(19) United States
(12) Patent Application Publication
(10) Pub. No.: US 2013/0340596 A1
(43) Pub. Date: Dec. 26, 2013

(54) DETACHABLE AND FOLDABLE INTEGRATED DRUM AND PROCESS FOR MANUFACTURING DRUM-PAD THEREOF

(71) Applicant: SHENZHEN ZHONGKAIXIN TECHNOLOGY CO., Guangdong (CN)

(72) Inventor: Jun Yao, Guangdong (CN)

(73) Assignee: SHENZHEN ZHONGKAIXIN TECHNOLOGY CO., LTD., Guangdong (CN)

(21) Appl. No.: 13/645,997

(22) Filed: Oct. 5, 2012

(30) Foreign Application Priority Data
Jun. 21, 2012 (CN) 201210207982.2

(51) Int. Cl. G10H 3/00; B29C 37/02

(52) U.S. Cl. 84/723; 264/161

(57) ABSTRACT

The invention discloses a detachable and foldable integrated drum including: a drum-pad which includes a base on which at least one drum body is provided, where the drum body has a tympan, a vibration is produced when the tympan is beaten, and a vibration sensor is provided within the drum body for producing an electrical audio signal in response to the vibration; and a host which is mounted detachably on the drum-pad, and adapted to process the electrical signal to cause a speaker to sound. Both the base and the drum body are made of flexible material, and thus the drum-pad is foldable. The drum-pad of the present invention is foldable and the tympan is small and thin, which can effectively reduce the volume of the drum-pad and make it easy to carry; meanwhile, the productivity is high.

### TECHNICAL FIELD

The present invention relates to the field of musical instrument technologies, and particularly, to a detachable and foldable integrated drum and the process for manufacturing the drum-pad thereof.

### TECHNICAL BACKGROUND

The electrical percussion instrument is the one in which a vibration signal produced by the physical beat is inputted to an audio source through a trigger, and converted into the needed tone by the audio source, and then converted into the sound audible for people by a speaker or earphone. The electrical drum in fact is a sensor used for receiving signals. In the moment that a drum stick beats a receiver of the clappers, the strength of the applied force is sensed by a sensor and transferred to drum audio source machine specialized for storing drum sound, and then the output tone is read and sent to the speaker to produce a sound.

In the traditional electronic drum, the drum-pad is unfoldable and thus is inconvenient to store and carry. For example, Chinese patent publication CN 102142248 A discloses an electronic drum-pad, and particularly relates to a drum-pad having a net-like tympan. The drum-pad includes the net-like tympan, a frame, a sensor for detecting the vibration of the tympan, and a supporting structure for supporting the sensor. The net-like tympan is pressed on the frame, the sensor is arranged under the tympan and in contact with the tympan, for detecting the beat on the tympan and outputting an electrical signal. The electronic drum-pad cannot be folded or winded, and thus it is impossible to reduce its volume to save space; further, for the absence of feel for resiliency when a player beats the tympan, the drum stick produces too much shake on hands, which would hurt the hand to some extent.

In the prior art, there are also some electronic drums having a drum-pad that can be winded. The volume of the electronic drum can be reduced to some extent to facilitate carrying and storing. For example, Chinese patent publication CN 2924718 Y disclosed a windable electronic drum, where a plurality of sensing keys are provided in a windable cushion, for receiving the beat to produce and transfer an electrical audio signal to a control box connected with the cushion. The cushion can be winded around the control box to facilitate the storing of the electronic drum. The sensing keys each include a vibration sensor, a vibrating conveying board and a tympan, which are sequentially provided on the cushion, so that a resonant vibration can be produced when the tympan is beaten, and the vibration is conveyed to the vibration sensor, so that the vibration sensor produces and transmits an electrical audio signal to the control box, allowing the control box to produce the corresponding audio effect. However, the electronic drum is disadvantageous in that the control box is fixed onto one side edge of the cushion; that is, the control box and the drum-pad are in a one-piece structure which cannot be separately. Due to the poor flexibility of the structure, it is not easy to manufacture, and thus the productivity of the electronic drum is extremely low. Further, for the absence of feel for resiliency when a player beats the tympan, the drum stick produces too much shake on hands, which would hurt the hand to some extent.

### SUMMARY OF THE INVENTION

An object of the invention is intended to solve the problem mentioned above by proposing a detachable and foldable integrated drum. The drum is easy to manufacture due to its separable structural design, so that the productivity is improved; with the foldable design, the volume can be reduced so that it is easy to carry and store; and based on the design of the drum-pad, a better hand feel of resilience is achieved when beating tympan; further, the hand will not be hurt by the drum stick.

The invention also proposes a process for manufacturing the drum-pad. The process is advantageous for its simplicity and is beneficial for automated-batch production.

The object is achieved with technical solutions below.

A detachable and foldable integrated drum, includes:

a drum-pad which includes a base on which at least one drum body is provided, here the drum body includes a tympan which produces a vibration when the tympan is beaten, and a vibration sensor provided within the drum body is adapted for producing an electrical audio signal in response to the vibration; and

a host which is mounted detachably to the drum-pad, and adapted to process the electrical audio signal to drive a speaker to sound.

Both the base and the drum body are made of flexible material, and thus the drum-pad is foldable.

Preferably, the base and the drum body are made by silica gel and/or rubber, and thus making the drum-pad foldable.

Further, the host and the drum-pad are arranged apart from one another, and the host and the vibration sensor are in communication with each other through a wireless communication technology.

Furthermore, the wireless communication technology is Bluetooth or other wireless communication technologies known by the skills in the art.

Further, the host and the drum-pad are arranged in contact with one another, and the host and the vibration sensor are in communication with each other through a wireline communication technology.

Furthermore, the host and the drum-pad are connected with each other through a slot, or male and female extension sockets, or conductive lines.

Furthermore, the wireline communication technology may include a flexible circuit, or a conductive line or other wireline communication technologies known by the skills in the art.

Further, one side of the drum body is located on the base, the other side of the drum body opposite to the base is provided with the tympan, a hardware is attached against the internal wall of the drum body, for preventing the deformation of the drum body and guarantee the tension of the tympan.

Furthermore, a support, which is within the drum body, is provided between the base and the tympan, the vibration sensor is fixed onto the support, and the side of the vibration sensor adjacent to the tympan is provide with a protective plate, which is used to convey the vibration to the vibration sensor and prevent the vibration sensor from being beaten.

Preferably, the support is a cylinder.

Furthermore, the cylinder is located at the central position within the drum body, the cylinder and the drum body are formed integrally or separately, to increase the resilience of the tympan, and when the tympan is beaten, the cylinder can prevent the tympan from being moved into the base directly and thus prevent the vibration sensor from being damaged.

Further, the periphery of the drum body is provided with a light guide, both two ends or either end of the light guide are provided with Light Emitting Diode (LED) lights, so that the periphery is lighten by the LED lights when the tympan is beaten, and the light guide and the LED lights are fixed onto the periphery of the drum body through a protective shield.

Further, the host and/or the drum-pad may include a power supply (e.g. a cell) or be connected externally to a power supply, the host and/or the drum-pad may be also provided with a number of function keys, so as to have functions of memory, volume control, power switch on or off, external pedal, audio output, USB, MIDI, etc., so that the host and/or the drum-pad can be diverse in functions.

Furthermore, a vent hole is provided on the base, so that when the tympan is beaten, the vent hole acts as the function of exhausting.

Preferably, the vent hole is provided at a position on the base corresponding to the central position of each drum body.

Further, a plurality of drum bodies are provided on the base on which a fold line is provided, and the base can be folded about the fold line.

Preferably, the drum body is of a cylindrical form, six bodies are provided on the base in such a way as to being symmetrically distributed about the fold line, and thus the six bodies can be folded by using the fold line, so that the volume of the drum-pad is reduced and it is easy to carry.

A process for manufacturing a drum-pad, including a step of producing a drum body, a step of producing a base, and a step of assembling the base and the drum body.

The step of producing the drum body includes:

a step of mixing and kneading of silica gel, in which ingredients are prepared by weight ratios and include 100 parts of dimethyl silicone crude rubber, 0.5 to 3 parts of dimethyl tertiary butyl peroxide hexane, 35 to 45 parts of precipitated white carbon black, and 8 parts of hydroxy silicone oil, then, the ingredients are mixed internally by a kneader, mixed by an open mill and a vulcanizer and packaged, and finally, the packaged product (i.e., the product obtained from the packaging) is cut into sheets of silica gel according to the desired standard thickness;

a step of immersing a hardware a surface treatment agent;

a step of molding of silica gel, in which in mold-locked production employing a two-layer die, the immersed hardware is placed in the lower-layer of the die, the silica gel is fed to the lower-layer of the die and vulcanized at a vulcanization temperature of 170±10° C. and the pressure of 200±5 kg/cm² for 80±3 seconds, and then excessive burrs of the drum body of silica gel are removed after the vulcanization; and

a step of surface screen printing treatment, in which a screen and a screen printing clamp are positioned on a screen printing machine, then the drum body of silica gel is placed on the screen printing clamp for surface screen printing, and then dried using the elevated temperature tunnel with a temperature of 190±10° C. for 10 to 15 minutes.

The step of producing the base includes:

a step of mixing and kneading of silica gel, in which ingredients are prepared by weight ratios and include 100 parts of dimethyl silicone crude rubber, 0.5 to 3 parts of dimethyl tertiary butyl peroxide hexane, 35 to 45 parts of precipitated white carbon black, and 8 parts of hydroxy silicone oil, then, the ingredients are mixed internally by a kneader, mixed by an open mill and a vulcanizer and packaged, and finally, the packaged product is cut into sheets of silica gel according to the desired standard thickness;

a step of molding of silica gel, in which in mold-locked production employing a two-layer die, the silica gel is fed to the lower-layer of the die and vulcanized at a vulcanization temperature of 170±10° C. and the pressure of 200±5 kg/cm² for 80±3 seconds, and then excessive burrs are removed from the base of silica gel after the vulcanization; and

a step of surface screen printing treatment, in which a screen and a screen printing clamp are positioned on a screen printing machine, then the base of silica gel is placed on the screen printing clamp for surface screen printing, and then dried using the elevated temperature tunnel with a temperature of 190±10° C. for 10 to 15 minutes.

The step of assembling the base and the drum body includes that the base and a plurality of bodies are bonded with each other by adhesives.

Compared with traditional technology, the present invention has the following effects:

1. The base and drum body are made of flexible material, and thus the drum-pad is foldable and the tympan is small and thin, which can effectively reduce the volume of the drum-pad and make it easy to carry;

2. The detachable design of the host and the drum-pad results in a more flexible structure in use and higher productivity; and

3. Through LED lights and light guide provided on the periphery of the drum body, the periphery of the drum body can be lighten when the tympan is beaten, thus the drum is more entertaining and interesting and the player's interests can be improved.

### BRIEF DESCRIPTION OF THE DRAWINGS

FIG. 1 is a schematic diagram showing the structure of the detachable and foldable integrated drum of an embodiment of the invention;

FIG. 2 is a schematic bottom view of the drum body shown in FIG. 1;

FIG. 3 is a schematic sectional view of the drum body shown in FIG. 1; and

FIG. 4 is a schematic diagram showing the state of the drum shown in FIG. 1, where the host and the drum-pad are separated.

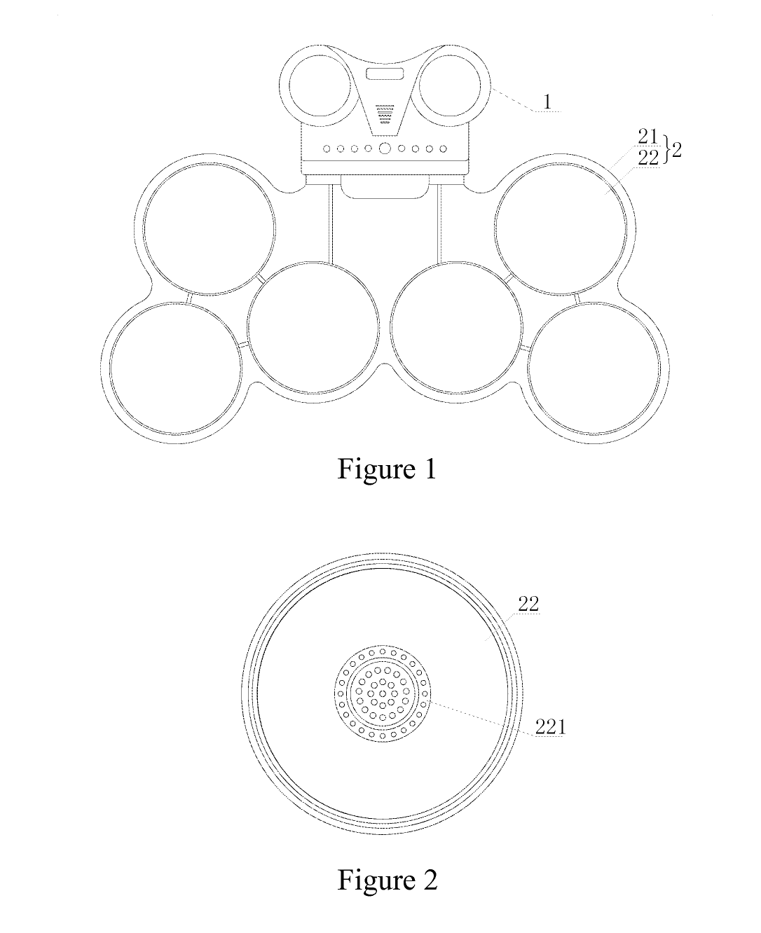

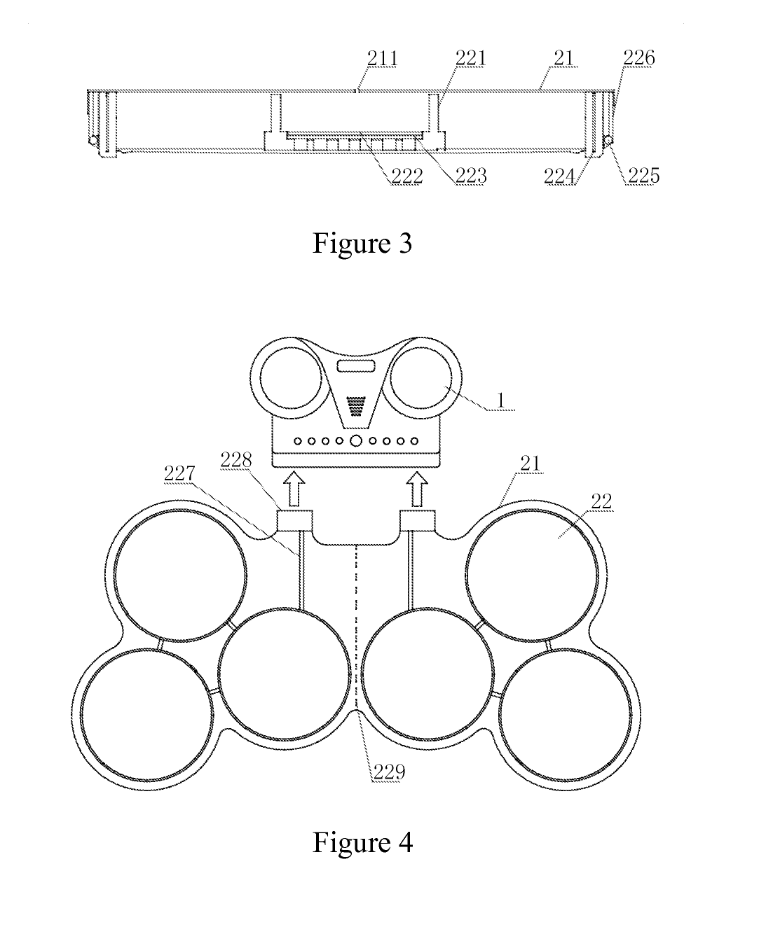

Reference list

| | | |
|---|---|---|
| 1: host; | 2: drum-pad; | 21: base; |
| 211: vent hole; | 22: drum body; | 221: cylinder; |
| 222: vibration sensor; | 223: protective plate; | 224: hardware; |
| 225: light guide; | 226: protective shield; | 227: conduction wire; |
| 228: plastic box; | 229: fold line. | |

The present invention is further described in detail below. However, the following examples are merely illustrative examples of the present invention, which do not represent or limit the scope of the present invention. The scope of the present invention is defined by the appended claims.

### DETAILED DESCRIPTION OF THE PREFERRED EMBODIMENTS

In order to explain the present invention and facilitate the understanding of the technical solution of the present invention, typical but non-limiting embodiments of the invention are provided as follows.

In one embodiment, a detachable and foldable integrated drum includes a host 1 and a drum-pad 2. The host 1 is mounted detachably to the drum-pad 2. The drum-pad 2 includes a base 21 on which six drum bodies 22 are provided. The drum body 22 is in a cylindrical form. One side of the drum body 22 is located on the base 21, and the other side of the drum body 22 opposite to the base is provided with a tympan. A cylinder 221 is provided between the base 21 and the tympan within the drum body 22, and a vibration sensor 222 is fixed onto the cylinder 221. The side of the vibration sensor 222 that is adjacent to the tympan is provided with a protective plate 223, which is used to convey a vibration to the vibration sensor 222 and prevent the sensor 222 from being beaten. A hardware 224 is attached against the internal wall of the drum body 22 to prevent the deformation of the drum body and guarantee the tension of the tympan. The periphery of the drum body is provided with a light guide 225, two ends of which are provided with LED (Light Emitting Diode) lights, so that the periphery of the drum body is lighten by the LED lights when the tympan is beaten. The light guide 225 and the LED lights are fixed onto the periphery of the drum body 22 through a protective shield 226.

In this embodiment, the drum-pad 2 may be inserted into the side of the host 1. The base is provided with a plastic box 228 within which a slot is provided. The host is provided with a plug matching the slot, to achieve the detachable connection between the drum-pad and the host. The vibration sensor 222 is connected to the host 1 through a flexible conduction wire 227, which conveys the electrical audio signal to the host, so that sound is generated by speakers provided in the host.

The drum body is made of silica gel using a production method including the steps of mixing and kneading of silica gel, immersing of hardware, molding of silica gel, and surface screen printing treatment. In the step of mixing and kneading of silica gel, ingredients are prepared by weight ratios and include 100 parts of dimethyl silicone crude rubber, 0.5 to 3 parts of dimethyl tertiary butyl peroxide hexane, 35 to 45 parts of precipitated white carbon black, and 8 parts of hydroxy silicone oil, then, the ingredients are mixed internally by a kneader, mixed by an open mill and a vulcanizer and packaged, and finally, the packaged product is cut into sheets of silica gel according to the desired standard thickness. In the step of immersing, the hardware is immersed by a surface treatment agent. In the step of molding of silica gel, in mold-locked production employing a two-layer die, the immersed hardware is placed in the lower-layer of the die, the silica gel is fed to the lower-layer of the die and vulcanized at a vulcanization temperature of 170±10° C. and the pressure of 200±5 kg/cm² for 80±3 seconds, and then excessive burrs of the drum body of silica gel are removed after the vulcanization. In the step of surface screen printing treatment, a screen and a screen printing clamp are positioned on a screen printing machine, then the drum body of silica gel is placed on the screen printing clamp for surface screen printing, and then dried using the elevated temperature tunnel with a temperature of 190±10° C. for 10 to 15 minutes. The tympan for the drum body made by this method may be small and thin.

The base is made of silica gel using a production method including the steps of mixing and kneading of silica gel, molding of silica gel, and surface screen printing treatment. In the step of mixing and kneading of silica gel, ingredients are prepared by weight ratios and include 100 parts of dimethyl silicone crude rubber, 0.5 to 3 parts of dimethyl tertiary butyl peroxide hexane, 35 to 45 parts of precipitated white carbon black, and 8 parts of hydroxy silicone oil, then, the ingredients are mixed internally by a kneader, mixed by an open mill and a vulcanizer and packaged, and finally, the packaged product is cut into sheets of silica gel according to the desired standard thickness. In the step of molding of silica gel, in mold-locked production employing a two-layer die, the silica gel is fed to the lower-layer of the die and vulcanized at a vulcanization temperature of 170±10° C. and the pressure of 200±5 kg/cm² for 80±3 seconds, and then excessive burrs of the base of silica gel are removed after the vulcanization. In the step of surface screen printing treatment, a screen and a screen printing clamp are positioned on a screen printing machine, then the base of silica gel is placed on the screen printing clamp for surface screen printing, and then dried using the elevated temperature tunnel with a temperature of 190±10° C. for 10 to 15 minutes. The base made by this method can be foldable, and thus its volume can be reduced for easy of carrying and storing.

In this embodiment, the six bodies 22 are bonded to the base 21 in such a way as to being symmetrically distributed about a fold line 229 provided on the base 21, and thus the six bodies can be folded by using the fold line 229, so that the volume of the drum-pad is further reduced for easy of carrying.

In use of the drum, the host 1 and the base 21 are connected with each other. A power in the host is operating upon switching on. A vibration, which is produced by the drum stick beating the tympan, is conveyed to the protective plate 223, and then further conveyed by the protective plate 223 to the vibration sensor 222 to produce an electrical audio signal, then the electrical audio signal is transferred to the host 1 by a conduction wire, to cause a speaker to produce a drum sound. At a position on the base 21 that corresponds to a central position of each drum body, there is provided a vent hole 211, which is used to control the amount of basic air flow needed in the process of vibration of the drum body in order to improve the stability of a vibrating wave.

In another embodiment, a detachable and foldable integrated drum includes a host and a drum-pad. The host is mounted detachably to the drum-pad. The drum-pad includes a base on which six drum bodies are provided. The drum body is in a cylindrical form. One side of the drum body is located on the base, and the other side of the drum body opposite to the base is provided with a tympan. A cylinder is provided between the base and the tympan within the body, and a vibration sensor is fixed onto the cylinder. The side of the vibration sensor that is adjacent to the tympan is provided with a protective plate, which is used to convey a vibration to the vibration sensor and prevent the sensor from being beaten. A hardware is attached against the internal wall of the drum body to prevent the deformation of the drum body from and guarantee the tension of the tympan. The periphery of the drum body is provided with a light guide, two ends of which are provided with LED lights, so that the periphery of the drum body is lighten by the LEDs when the tympan is beaten. The light guide and the LED lights are fixed onto the periphery of the drum body through a protective shield.

In this embodiment, the vibration sensor is in communication with the host through Bluetooth, which conveys the electrical audio signal to the host to cause speakers provided in the host to produce sounds.

In use of the drum, a power in the host and that in the base are operating upon switching on. A vibration, which is produced by the drum stick beating the tympan, is conveyed to the protective plate, and then further conveyed by the protective plate to the vibration sensor to produce an electrical audio signal, then the electrical audio signal is transmitted to the outside by a transmission module provided on the drum-pad. A corresponding receiving module is provided on the host to receive the electrical audio signal, and then the drum sound is produced by a speaker. At a position on the base that corresponds to a central position of each drum body, there is provided with a vent hole, which is used to control the amount of basic air flow needed in the process of vibration of the drum body in order to improve the stability of a vibrating wave.

The detailed structural features and manufacturing methods of the present invention are illustrated above. However, the present invention is not limited to the detailed structural features and manufacturing methods mentioned above; that is, the implement of the present invention is not necessarily limited to the above detailed structural features and manufacturing methods. Those skilled in the art should understand that any improvements to the present invention, the equivalent substitutions to the parts used in present invention, additional auxiliary parts, and the selection for the specific implementations shall fall within the scopes of the present invention.

1. A detachable and foldable integrated drum, characterized by comprising:
a drum-pad including a base on which at least one drum body is provided, wherein the drum body includes a tympan which produces a vibration when being beaten, and a vibration sensor provided within the drum body is adapted for producing an electrical audio signal in response to the vibration;
a host which is mounted detachably to the drum-pad, and adapted to process the electrical audio signal to drive a speaker to sound;
both the base and the drum body are made of flexible material, so that the drum-pad is foldable.

2. The drum of claim 1, characterized in that the host and the drum-pad are arranged apart from one another, and the host and the vibration sensor are in communication with each other through a wireless communication technology.

3. The drum of claim 1, characterized in that the host and the drum-pad are arranged in contact with one another, and the host and the vibration sensor are in communication with each other through a wireline communication technology.

4. The drum of claim 1, characterized in that one side of drum body is located on the base, the other side of the drum body opposite to the base is provided with the tympan, and a hardware is attached against the internal wall of the drum body.

5. The drum of claim 3, characterized in that the host and the drum-pad are connected with each other through a slot, or male and female extension sockets, or a conductive line, and the host is connected with the vibration sensor through conduction wire.

6. The drum of claim 4, characterized in that a support, which is within the drum body, is provided between the base and the tympan, the vibration sensor is fixed onto the support, and the side of the vibration sensor adjacent to the tympan is provide with a protective plate, which is used to convey the vibration to the vibration sensor and prevent the vibration sensor from being beaten.

7. The drum of claim 4, characterized in that a light guide is provided at the periphery of the drum body, both two ends or either end of the light guide is provided with Light Emitting Diode lights, so that the periphery is lighten by the Light Emitting Diode lights when the tympan is beaten, and the light guide and the Light Emitting Diode lights are fixed onto the periphery of the drum body through a protective shield.

8. The drum of claim 4, characterized in that the base is provided with a vent hole.

9. The drum of claim 4, characterized in that a plurality of the drum bodies are provided on the base, and the base is foldable about a fold line provided on the base.

10. A process for manufacturing a drum-pad, comprising a step of producing a drum body, a step of producing a base, and a step of assembling the base and the drum body, wherein
the step of producing the drum body includes:
a step of mixing and kneading of silica gel, in which ingredients are prepared by weight ratios, then, the ingredients are mixed internally by a kneader, mixed by an open mill and a vulcanizer and packaged, and finally, the packaged product is cut into sheets of silica gel according to the desired standard thickness;
a step of immersing a hardware with a surface treatment agent;
a step of molding of silica gel, wherein in mold-locked production employing a two-layer die, the immersed hardware is placed in the lower-layer of the die, the silica gel is fed to the lower-layer of the die and vulcanized, and then excessive burrs of the drum body of silica gel are removed after the vulcanization; and
a step of surface screen printing treatment, in which a screen and a screen printing clamp are positioned on a screen printing machine, then the drum body of silica gel is placed on the screen printing clamp for surface screen printing, and then dried using an elevated temperature tunnel;
the step of producing the base includes:
a step of mixing and kneading of silica gel, in which ingredients are prepared by weight ratios, then, the ingredients are mixed internally by a kneader, mixed by an open mill and a vulcanizer and packaged, and finally, the packaged product is cut into sheets of silica gel according to the desired standard thickness;
a step of molding of silica gel, wherein in mold-locked production employing a two-layer die, the silica gel is fed to the lower-layer of the die and vulcanized, and then excessive burrs of the base of silica gel are removed after the vulcanization; and
a step of surface screen printing treatment, in which a screen and a screen printing clamp are positioned on a screen printing machine, then the base of silica gel is placed on the screen printing clamp for surface screen printing, and then dried using the elevated temperature tunnel.
